(19) United States
(12) Patent Application Publication
(10) Pub. No.: US 2015/0135721 A1
(43) Pub. Date: May 21, 2015

(54) METHOD FOR SUPPORTING A MAINS FREQUENCY

(71) Applicant: Siemens Aktiengesellschaft, Munich (DE)

(72) Inventors: Martin Bennauer, Bottrop (DE); Edwin Gobrecht, Ratingen (DE); Matthias Heue, Bochum (DE)

(73) Assignee: Siemens Aktiengesellschaft, Munich (DE)

(21) Appl. No.: 14/413,334

(22) PCT Filed: Jun. 13, 2013
(86) PCT No.: PCT/EP2013/062202

§ 371 Date: Jan. 7, 2015

(30) Foreign Application Priority Data
Jul. 12, 2012 (EP) 12176050.8

(51) Int. Cl. F01K 7/24; F01K 23/10; F02C 9/00

(52) U.S. Cl. CPC F01K 7/24; F02C 9/00; F01K 23/10
USPC 60/773; 60/652

(57) ABSTRACT

A method for supporting a mains frequency in an energy generation plant is provided. The energy generation plant may be operated using unthrottled high-pressure valves, and the throttling action of the medium-pressure valves may be canceled when the mains frequency drops.

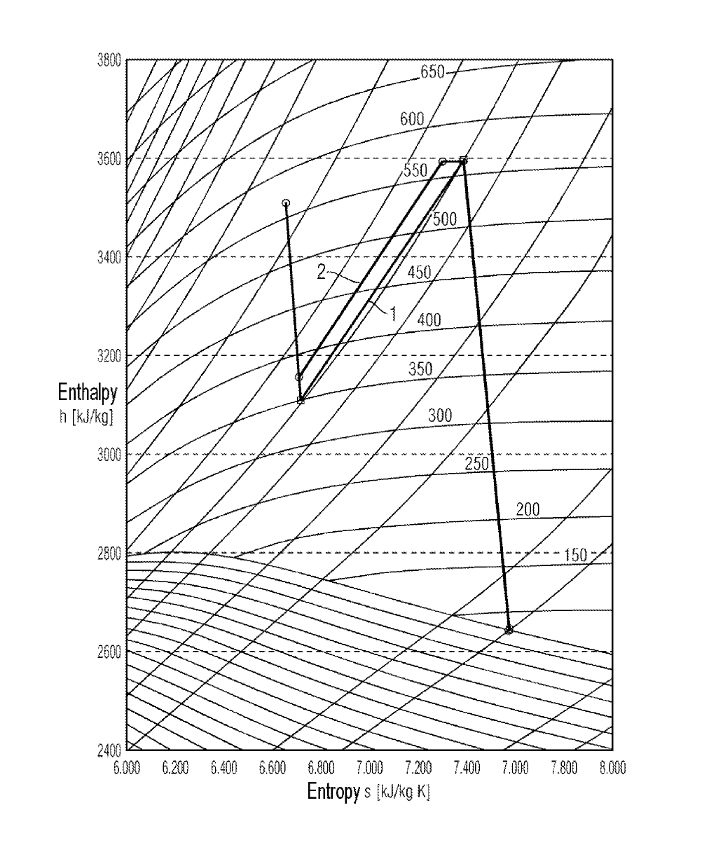

### CROSS REFERENCE TO RELATED APPLICATIONS

This application is the US National Stage of International Application No. PCT/EP2013/062202 filed Jun. 13, 2013, and claims the benefit thereof. The International Application claims the benefit of European Application No. EP12176050 filed Jul. 12, 2012. All of the applications are incorporated by reference herein in their entirety.

### FIELD OF INVENTION

The invention relates to a method for supporting a grid frequency of a power generation plant comprising a steam turbine, wherein the steam turbine comprises a high-pressure turbine section and an intermediate-pressure turbine section, wherein an intermediate-pressure valve is arranged upstream of the intermediate-pressure turbine.

### BACKGROUND OF INVENTION

Combined cycle power plants as an embodiment of a power generation plant generally comprise a gas turbine, a steam turbine and a generator which is torque-coupled to the gas turbine and steam turbine. In the field of the local supply of power, the gas turbines of such combined cycle power plants are predominantly used to support the grid frequency. This is effected by reducing the power of the gas turbine when the grid frequency rises and by raising the power of the gas turbine when the grid frequency drops. The power of the steam turbine essentially follows the power of the gas turbine with a certain delay, which is associated with the inertia of the boiler. Thus, the steam turbine is not actively involved in the frequency support.

Steam power plants generally comprise a boiler, a steam turbine and an electric generator. For frequency support in such steam power plants, the steam turbine is operated with throttled fresh steam valves and reduced boiler power. If the grid frequency drops, the throttling is released and the boiler power is increased. However, opening the fresh steam valves causes the pressure in the fresh steam system to drop, which in turn causes, for a short time, more water to be evaporated than in static operation for that boiler power. This causes a rise in the fresh steam mass flow rate. With the fresh steam mass flow rate, the turbine power also rises briefly. In addition to opening the fresh steam valve, the boiler power is simultaneously increased. However, this change is slow to take effect. This means that, effectively, there is a quick increase in power as a consequence of releasing the throttling, which however quickly abates again.

Another possible measure to increase power at short notice is, in the case of purely steam power plants, to partially or entirely disconnect the preheating section. This increases the mass flow rate through the steam turbine, which leads to an increase in electrical power and compensates for a reduction in power which is caused by the slow but long-term increase in power from increasing the boiler power. In summary, it can be said that combining all these effects can achieve a quick and long-term increase in power which generally fulfils the contractual grid requirements.

Feeding in renewable energy, such as solar energy or wind energy, leads to greater fluctuations in the grid. This also means increased need for the steam turbine to participate in frequency support also in the combined cycle power plant. It is commonly not desirable for the gas turbine in a combined cycle power plant to be operated at reduced power. Although the power of the gas turbine can be increased substantially faster than is the case for the boiler power in a purely steam power plant, it is desirable for the steam turbine to participate in the further increase in power. It is also to be taken into account that a preheating section, like that present in a steam power plant, is not present in a combined cycle process.

Currently, these demands are achieved, in combined cycle power plants, by throttling the fresh steam valves upstream of the high-pressure turbine section. However, the gas turbines in combined cycle power plants should not be operated at reduced power for long periods. For that reason, the gas turbines are operated at full load and the steam turbines are operated with throttled valves. Now, if in the event of a power increase the throttling is released, the power quickly increases through the release of stored steam, but only that power increase corresponding to the throttling losses remains in the long term. Further participation of the steam turbine beyond this short-term effect has until now not been taken into account.

### SUMMARY OF INVENTION

It is at this point that the invention comes in, an object of the invention being to propose an improved method for operating a power generation plant.

This object may be achieved, in one embodiment, by a method for supporting a grid frequency of a power generation plant comprising a steam turbine, wherein the steam turbine includes a high-pressure turbine section and an intermediate-pressure turbine section, wherein an intermediate-pressure valve is arranged upstream of the intermediate-pressure turbine section, wherein the power generation plant is operated with unthrottled high-pressure valves.

An embodiment of the invention thus proceeds from the thought of throttling the intermediate-pressure valves instead of throttling the high-pressure valves. This has essentially two effects. On one hand, it reduces the power produced by the high-pressure turbine section since the expansion is reduced by the increasing pressure in the cold reheating. Furthermore, the power produced by the intermediate-pressure turbine section is reduced since throttling losses ensue on the intermediate-pressure side.

The desired effect is that, for example in a combined cycle power plant, the gas turbine can be operated at full power, with the steam turbine being operated with throttled intermediate-pressure valves and increased reheater pressure. If the grid frequency drops, the throttling of the intermediate-pressure valves can be released, if the grid frequency drops, whereby more power is available long-term. Further advantageous developments are indicated in the subclaims.

One effect according to an embodiment of the invention is that the steam turbine can now participate more in increasing power and thus a greater amount of power can be fed more quickly into the grid. The consequence is that the requirements of the load dispatch center can be fulfilled. A further effect is that the overall efficiency increases.

In essence, the same method can also be applied for a drop in load, which is also required for frequency support.

### BRIEF DESCRIPTION OF THE DRAWINGS

The invention will be explained in more detail with reference to one exemplary embodiment.

The FIGURE shows an h-s chart.

### DETAILED DESCRIPTION OF INVENTION

A combined cycle power plant essentially comprises a steam turbine and a gas turbine, with an electric generator generally being coupled in torque-transmitting fashion between the gas turbine and the steam turbine. Embodiments of the invention can also be applied to combined cycle power plants having multiple shafts. Embodiments of the invention can also be applied to purely steam power plants. The hot gas stream flowing out of a gas turbine may be used in a boiler to generate steam for the steam turbine. The steam turbine is generally split into a high-pressure turbine section, an intermediate-pressure turbine section and a low-pressure turbine section. The fresh steam flows first into the high-pressure turbine section. After the high-pressure turbine section, the steam flows through a reheater, where it is brought up to a higher temperature, and then flows into the intermediate-pressure turbine section. After the intermediate-pressure turbine section, the steam flows into a low-pressure turbine section and thence into a condenser where it is converted back to water.

A fresh steam valve is arranged in the fresh steam line, upstream of the high-pressure turbine section, and controls the flow through the fresh steam line. An intermediate-pressure valve is arranged upstream of the intermediate-pressure turbine section and is also configured such that it can control the flow through an intermediate-pressure supply line to the intermediate-pressure turbine section.

The combined cycle power plant is thus operated with throttled intermediate-pressure valves, with the throttling of the intermediate-pressure valves being released if the grid frequency drops. This supports a method for supporting a grid frequency of a combined cycle power plant, wherein the combined cycle power plant is operated with unthrottled high-pressure valves. The gas turbine is operated at essentially full power. If, in the case of a drop in grid frequency, more power is required, the throttling of the intermediate-pressure valves can be released and more power is available long-term.

The FIGURE shows the corresponding enthalpy-entropy chart of the combined cycle power plant according to an embodiment of the invention. Line 1 shows a combined cycle power plant according to the prior art. Line 2 shows a changed profile of the h-s chart of the combined cycle power plant according to an embodiment of the invention, wherein here the profile is represented with throttled intermediate-pressure valves.

1. A method for supporting a grid frequency of a power generation plant comprising a steam turbine, wherein the steam turbine comprises a high-pressure turbine section and an intermediate-pressure turbine section, comprising:
arranging an intermediate-pressure valve upstream of the intermediate-pressure turbine section, and
operating the power generation plant with unthrottled high-pressure valves.

2. The method as claimed in claim 1, wherein the power generation plant is operated with throttled intermediate-pressure valves and, if the grid frequency drops, the intermediate-pressure valves are unthrottled.

3. The method as claimed in claim 1, wherein the power generation plant is formed as a combined cycle power plant.

4. The method as claimed in claim 3, wherein the gas turbine is operated at essentially full power.

5. The method as claimed in claim 1, wherein the power generation plant is formed as a steam power plant.

6. The method as claimed in claim 1, wherein the intermediate-pressure turbine section is fluidically connected to a reheater unit.
